(19) United States
(12) Patent Application Publication
(10) Pub. No.: US 2024/0377340 A1
(43) Pub. Date: Nov. 14, 2024

(54) CONTROLLING X-RAY MACHINE FOR FOREIGN MATERIAL DETECTION IN A GOOD

(71) Applicant: Greyscale AI, Fremont, CA (US)

(72) Inventors: Brian Green, Fairfax Station, VA (US); Travis Vaughn, Odessa, FL (US); Mateo Dennehy, Vicente López (AR)

(21) Appl. No.: 18/660,038

(22) Filed: May 9, 2024

Related U.S. Application Data
(60) Provisional application No. 63/500,965, filed on May 9, 2023.

(51) Int. Cl. G01N 23/18; G01N 23/04; G01N 23/083; G01N 23/10; G06K 7/00; G06T 7/00

(52) U.S. Cl. CPC G01N 23/18; G01N 23/04; G01N 23/083; G06K 7/0004; G06T 7/0008; G01N 23/10; G01N 2223/306; G01N 2223/401; G01N 2223/421; G01N 2223/639; G01N 2223/643; G01N 2223/645; G01N 2223/652; G06T 2207/10116

(57) ABSTRACT

Disclosed herein are systems and methods for detecting foreign material in a good. A system controls an X-ray machine to capture an image of a good. The system analyzes the image captured by the X-ray machine by applying one or more of a foreign material detection algorithm and a foreign material model to the image. The system determines whether the good includes a foreign material comprising a challenge card by detecting at least one marking component on the foreign material when analyzing the image, wherein the challenge card includes the at least one marking component and a challenge material.

### CROSS-REFERENCE TO RELATED APPLICATION(S)

This application claims the benefit under 35 U.S.C. § 119 (c) to U.S. Provisional Application 63/500,965, filed May 9, 2023, and entitled “CONTROLLING X-RAY MACHINE FOR FOREIGN MATERIAL DECTION IN A GOOD,” which is hereby incorporated herein by reference in its entirety.

### FIELD

The various examples herein relate to quality control for manufactured products, packaged products, and/or food products.

### BACKGROUND

When goods are placed in their final packaging, it is typically near the end of the production process after the good has gone through extensive manufacturing or manipulation steps. Each of these steps could pose a risk for foreign materials accidentally being included in the good that would reach the ultimate consumer. This can cause harm to both the product and the consumer.

Many production lines now include some type of system to attempt to detect this foreign material. These systems operate by being placed initially in a first production mode. In order to test that these machines are accurately detecting the foreign materials, the production lines may be required to stop and the machines must be placed into a different challenge mode. Specific inputs may be required to be put into the machine detecting the foreign materials, and the results of the challenge must be manually checked. This leads to inefficiencies or interruptions in production and reduced verification tests in an effort to maximize the amount of product processed, reducing the overall effectiveness and efficiency of the system and increasing the risk of product recalls.

### BRIEF SUMMARY

Discussed herein are various methods and systems for detecting foreign materials in a good. A system controls an X-ray machine to capture an image of a good. The system analyzes the image captured by the X-ray machine by applying one or more of a foreign material detection algorithm and a foreign material model to the image. The system determines whether the good includes a foreign material comprising a challenge card by detecting at least one marking component on the foreign material when analyzing the image, wherein the challenge card includes the at least one marking component and a challenge material. In some instances, the challenge card further includes a carrier for identifying information, such as a radio frequency identification (RFID) tag or a barcode, that carries information about the challenge material. This RFID tag can notify the system either of the presence of the challenge card in the good or of the challenge material included on the challenge card such that the system can cross reference its own determination of the challenge material with the identifying information, automating the challenge process.

By utilizing these challenge cards with at least one marking component and a challenge material, a system can be tested without having to stop a production line or change the mode of a machine. The system can be configured to automatically carry out a challenge procedure upon the detection of the at least one marking component on the challenge card. In instances where carriers for identifying information are further included on the card, the determination of characteristics about the challenge material can be further automated. By maintaining the system in a singular mode and by automating the verification procedure, the machinery controlled by the processors and the systems described herein can operate at a higher efficiency and can continue processing other products while the challenge procedure is carried out by the system. As it is also simpler to perform the testing, testing is likely to be done more often, thereby increasing the accuracy of the testing procedures.

In Example 1, a method comprises (a) controlling, by one or more processors, an X-ray machine to capture an image of a good; (b) analyzing, by the one or more processors, the image captured by the X-ray machine by applying a foreign material detection algorithm and a foreign material model to the image; and (c) determining, by the one or more processors, whether the good includes a foreign material comprising a challenge card by detecting at least one marking component on the foreign material when analyzing the image, wherein the challenge card comprises the at least one marking component and a challenge material.

Example 2 relates to the method of Example 1, further comprising (a) determining, by the one or more processors and based on the analyzing of the image, that the good includes the foreign material; and one or more of (i) outputting, by the one or more processors, a signal to a notification device indicating that the good should be removed from production; and (ii) controlling, by the one or more processors, a transport system to automatically remove the good from production.

Example 3 relates to the method of Example 1, wherein the at least one marking component is recognizable by the X-ray machine as an identifier of the challenge card or the challenge material.

Example 4 relates to the method of Example 1, wherein the at least one marking component comprises at least one of: (a) at least two marking components positioned in a particular arrangement; (b) a particular shape of the at least one marking component; (c) a particular material comprising different X-ray absorption properties than the challenge material; and (d) at least two marking components.

Example 5 relates to the method of Example 4, wherein the particular arrangement of the at least two marking components comprises one or more of: a placement of the at least two marking components in a ring around the challenge material at known rotations around the challenge material and in known ratios of relative size and distance, an arrangement of the at least two marking components on a first end of the challenge card, and wherein the challenge component is placed on a second end of the challenge card, and any geometrical shape around the challenge component.

Example 6 relates to the method of Example 4, wherein determining that the good includes the challenge card comprises determining, by the one or more processors, that the particular arrangement of the plurality of marking components matches a predefined challenge arrangement.

Example 7 relates to the method of Example 1, wherein each of the at least one marking components has different X-ray absorption properties than the challenge material, wherein each of the at least one marking components comprises a material that absorbs a greater percentage of X-rays emitted by the X-ray machine than the challenge material.

Example 8 relates to the method of Example 1, wherein the challenge card further comprises an RFID tag, and wherein the method further comprises: (a) receiving, by the one or more processors and via an RFID reader, additional descriptive information of the challenge material from the RFID tag; and (b) updating, by the one or more processors, the foreign material model with the additional descriptive information of the challenge material.

Example 9 relates to the method of Example 1, wherein the X-ray machine comprises a photon counting X-ray machine, and wherein the image comprises a photon X-ray image.

Example 10 relates to the method of Example 1, wherein each of the at least one marking components further has a particular shape.

Example 11 relates to the method of Example 1, wherein the challenge card further comprises one or more of a barcode and a serial number, and wherein the method further comprises: (a) controlling, by the one or more processors, a camera to capture an image of the one or more of the barcode and the serial number; (b) determining, by the one or more processors, additional descriptive information of the challenge material based on the one or more of the barcode and the serial number; and (c) updating, by the one or more processors, the foreign material model with the additional descriptive information of the challenge material.

Example 12 relates to the of Example 1, further comprising in response to determining that the foreign material is the challenge card, updating, by the one or more processors, the foreign material model to include information descriptive of the challenge material.

Example 13 relates to the method of Example 12, wherein updating the foreign material model comprises: (a) in response to determining that the foreign material is the challenge card: (i) detecting, by the one or more processors, the challenge material in the image; (ii) determining, by the one or more processors, a unique signature for the challenge material; and (iii) updating, by the one or more processors, the foreign material model to include the unique signature for the challenge material.

Example 14 relates to the method of Example 1, wherein the challenge card further comprises a radio frequency identification (RFID) tag, and wherein the method further comprises: (a) failing to detect, by the one or more processors, that the good includes the foreign material comprising the challenge card; and (b) in response to failing to detect that the good includes the foreign material comprising the challenge card, receiving, by the one or more processors via a radio frequency identification (RFID) reader, a signal including information stored on the RFID tag on the challenge card.

Example 15 relates to the method of Example 1, wherein the challenge card comprises a first challenge card, and wherein a second challenge card comprises a secondary identification tag and a challenge material for the second challenge card, wherein the method further comprises: (a) receiving, by the one or more processors, the secondary identification tag; (b) extracting, by the one or more processors, a unique signature for the challenge material for the second challenge card from the secondary identification tag; and (c) updating, by the one or more processors, the foreign material model to include the unique signature for the challenge material for the second challenge card, wherein receiving the secondary identification tag comprises one or more of: (i) receiving, by the one or more processors via a radio frequency identification (RFID) reader, the secondary identification tag from an RFID tag on the second challenge card, and (ii) receiving, by the one or more processors via a barcode scanner, the secondary identification tag from a barcode on the second challenge card.

Example 16 relates to the method of Example 15, further comprising: (a) sending, by the one or more processors, the updated foreign material model to a server device with an indication of the challenge material.

Example 17 relates to the method of Example 1, further comprising: (a) downloading, by the one or more processors, a universally updated foreign material model from a server device; and (b) replacing, by the one or more processors, the updated foreign material model with the universally updated foreign material model.

Example 18 relates to the method of Example 1, wherein the good comprises a first good, wherein the challenge material comprises a first instance of the challenge material, wherein controlling the X-ray machine to capture the image of the first good comprises controlling, by the one or more processors, the X-ray machine to capture the image of the first good while in a scan mode, and wherein the method further comprises: (a) controlling, by the one or more processors, the X-ray machine to capture an image of a second good while in the scan mode; (b) analyzing, by the one or more processors, the image of the second good captured by the X-ray machine by applying the foreign material detection algorithm and the foreign material model to the image; (c) determining, by the one or more processors, that a second instance of the challenge material has a same signature as the first instance of the challenge material of the challenge card; (d) determining, by the one or more processors, that the at least one marking component is not present in the image; and (c) outputting, by the one or more processors, an alert that the second good includes the second instance of the challenge material and that the second good should be removed from production.

In Example 19, a device comprising one or more processors is configured to (a) control an X-ray machine to capture an image of a good; (b) analyze the image captured by the X-ray machine by applying a foreign material detection algorithm and a foreign material model to the image; and (c) determine whether the good includes a foreign material comprising a challenge card by detecting at least one marking component on the foreign material when analyzing the image, wherein the challenge card comprises the at least one marking component and a challenge material.

In Example 20, a non-transitory computer-readable storage medium has stored thereon instructions that, when executed, cause one or more processors of a computing device to (a) control an X-ray machine to capture an image of a good; (b) analyze the image captured by the X-ray machine by applying a foreign material detection algorithm and a foreign material model to the image; and (c) determine whether the good includes a foreign material comprising a challenge card by detecting at least one marking component on the foreign material when analyzing the image, wherein the challenge card comprises the at least one marking component and a challenge material.

While multiple examples are disclosed, still other examples will become apparent to those skilled in the art from the following detailed description, which shows and describes illustrative examples. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating an example system and operating environment for the techniques described herein.

FIG. 2 is a block diagram illustrating a more detailed example of a computing device configured to perform the techniques described herein.

FIGS. 3A-3L are conceptual diagrams illustrating example configurations of challenge cards, as described in accordance with the techniques of this disclosure

FIG. 4 is a flowchart illustrating an example method for detecting foreign material in a good, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

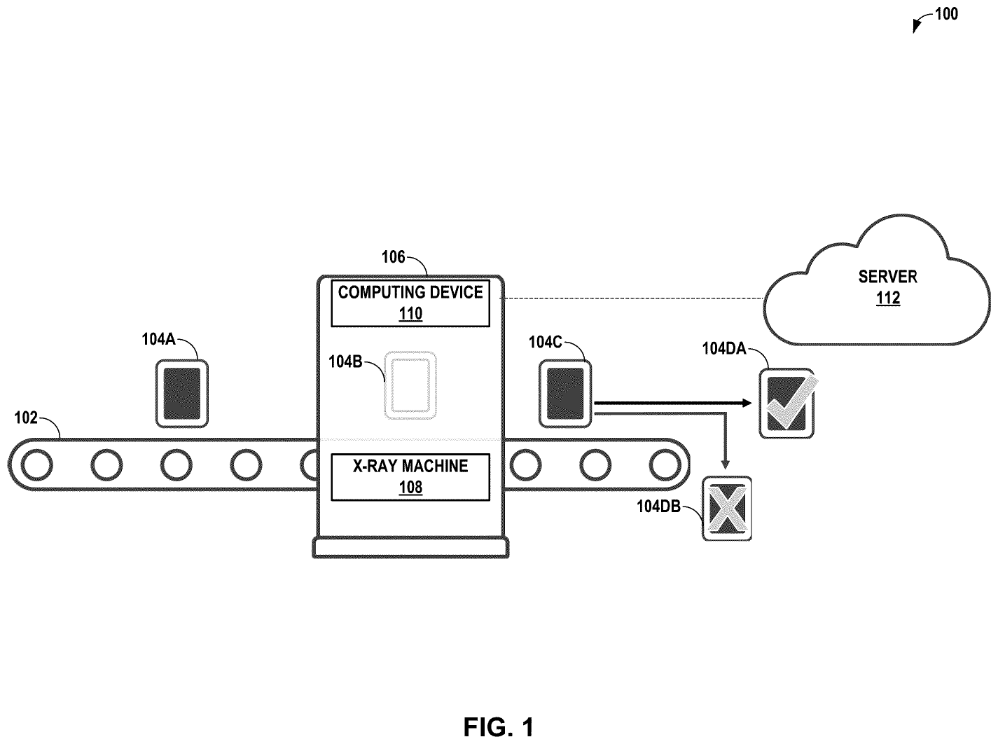

FIG. 1 is a conceptual diagram illustrating an example system 106 and operating environment 100 for the techniques described herein. In the example of FIG. 1, operating environment 100 includes transport system 102, good 104 (depicted at various times 104A-104DA/104DB), foreign material detection system 106, X-ray machine 108, and computing device 110. In some instances, computing device 110 may be in communication with server 112 in order to properly execute the techniques described herein, but may in other instances perform the techniques entirely or partially locally without relying on the communication with server 112. In still other instances, X-ray machine 108 may communicate directly with server 112, bypassing computing device 110, with server 112 performing each of the techniques elsewhere attributed to computing device 110.

Transport system 102 may be any device or system configured to automatically move good 104 through operating environment 100, including through foreign material detection system 106 and/or through other portions of the production process. For instance, transport system 102 may be any one or more of a belt system, a roller system, a motorized roller system, and an overhead conveyor system.

Good 104, depicted at various stages of the production process at times 104A-104DA/104DB, may be any good that goes through a manufacturing or assembly process, so long as that process includes at least one alteration process (e.g., an alteration of a size or state of a good, connecting two or more pieces of a good, separating two or more pieces of the good, placing a finished good in packaging, or any other form of combining, separating, altering, or packaging a product).

Foreign material detection system 106 may be any piece of machinery that is configured to receive good 104 along transport system 102. Foreign material detection system 106 may include X-ray machine 108 and computing device 110. Foreign material detection system 106 may at least utilize computing device 110 and X-ray machine 108 in order to determine, at time 104B, whether good 104 includes a foreign material, such as a challenge card.

X-ray machine 108 may be any device capable of emitting X-rays in order to capture an X-ray image of good 104 at time 104B, e.g., while good 104 is inside foreign material detection system 106. Operation of X-ray machine 108 may be controlled by computing device 110, which may both be physically incorporated into foreign material detection system 106 or may be physically separate devices. One example of X-ray machine 108 is a photon counting X-ray machine.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computing system, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

In some instances, computing device 110 may store a foreign material detection model locally and/or may execute a foreign material detection algorithm locally. In other instances, computing device 110 may be in communication with server 112. Computing device 110 may send the image of good 104 to server 112, and server 112 may store the foreign material detection model locally and/or may execute the foreign material detection algorithm on the image. For the purposes of this disclosure, operations will be described with respect to computing device 110, but any process or technique performed locally by computing device 110 may also be performed remotely by server 112.

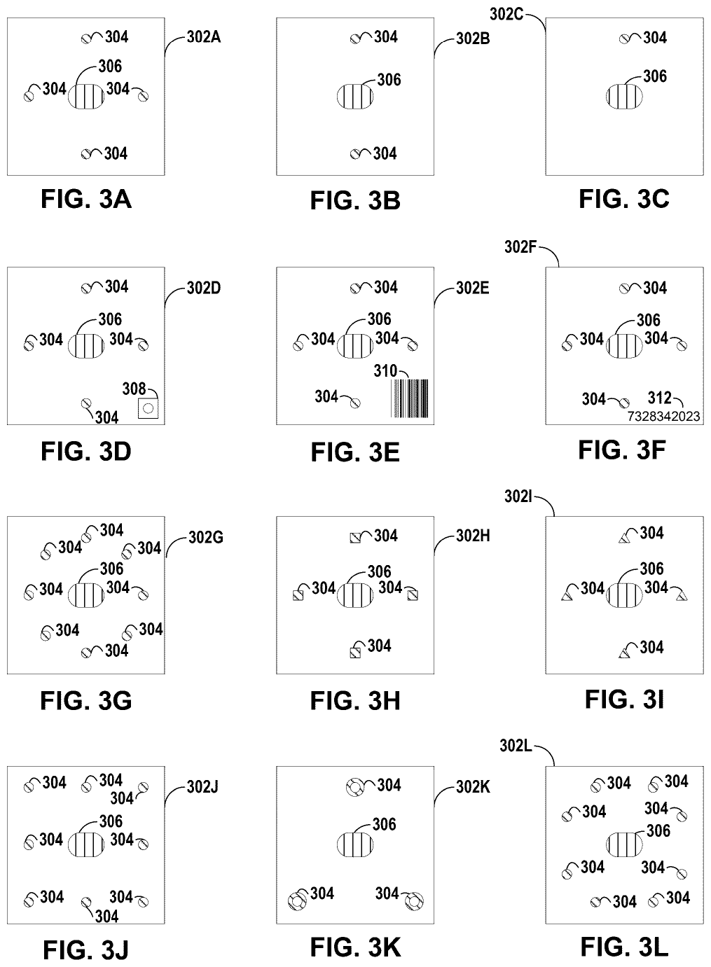

In accordance with the techniques of this disclosure, computing device 110 controls X-ray machine 108 to capture an image of a good 104, such as when good 104 is inside foreign material detection system 106 at time 104B. Computing device 110 analyzes the image captured by X-ray machine 108 by applying a foreign material detection algorithm and a foreign material model to the image. Computing device 110 determines whether good 104 includes a foreign material, the foreign material being a challenge card, by detecting at least one marking component on the foreign material when analyzing the image. The challenge card may include the at least one marking component and a challenge material. Further examples of potential configurations for a challenge card are shown in FIGS. 3A-3L.

If computing device 110 determines that good 104 does not contain the foreign material at time 104C, computing device 110 may allow good 104 to continue through the packaging process to arrive at a finalized version at time 104DA. Alternatively, if computing device 110 determines that good 104 includes the foreign material, computing device 110 may output a signal to notify a user of the presence of the foreign material so that good 104 may be removed at time 104DB.

Operating environment 100 may be designed to automatically detect an X-ray challenge piece to verify that X-ray machine 108 is properly working. The X-ray may be regularly challenged with a known standard size and material. This provides a record for compliance with regulatory requirements and also reduces risk of large recalls.

The techniques described herein may create an X-ray test card with properties that are automatically recognized by X-ray machine 108. This removes the need for an operator to put the X-ray machine into a “challenge” mode or manually document the time and challenge piece used. The process for challenging the machine may be as follows, in one example.

X-ray machine 108 may be running with products running in production mode. A user may place the test card on a product. The user may then place the combined test card and product onto the production line and transport system 102, referred to as the “challenge”. X-ray machine 108 may create an X-ray image of the product and computing device 110 may run inspection algorithms to find foreign materials, where the challenge is detected. Computing device 110 may send a signal to the product rejection mechanism and the challenge is removed from the production line. Each image where foreign materials are detected may be sent to a subsequent algorithm to determine if it is a challenge. The challenge detection algorithm may confirm if the challenge piece is recognized and adds the data to the inspection record (e.g., the foreign material detection model). The inspection record may be transferred from the on-site inspection machine to the cloud-based database at server 112 of inspections. A cloud-based application analyzes the database and provides reports about compliance of challenges to authorized users.

The techniques of this disclosure may use a specific arrangement of marker X-ray detectable pieces that creates a signature in the resulting X-ray image. The foreign material of interest (the center piece) may be surrounded by several “marker” shapes that are placed in known ratios of relative size and distance from the center piece and placed at known rotations around the center pieces.

The marker material may be specifically chosen to absorb a significant amount of the X-ray compared to the center piece (also referred to herein as the “challenge material”). This allows for simple detection by algorithms in comparison to the center piece and the rest of the product.

The signature of the markers may be unique for each type of challenge material of interest. For example, the signature of a 1.5 mm sphere of stainless steel is different from the signature of a 3.0 mm sphere of aluminum. This is accomplished by using different sized rings and placing the rings in a different pattern around the foreign material of interest.

The signatures of the objects in the challenge card may be optimized using the position of the fiducials (e.g., marking components) to reduce the risk of aligning them within the view of the X-Ray. There is always an opportunity to align two fiducials of the challenge card. The specific arrangements prevent alignment of three that would reduce the ability to determine unique signatures.

The techniques described herein may use machine learning models to do material classification of the objects in the challenge piece to determine what are the markers and which is the “challenge” material of interest. These machine learning models are trained to recognize the challenge material of interest and also the other materials that make up the signature of the challenge pieces.

The techniques described herein may further use an RFID tag in the challenge piece and an RFID reader in X-ray machine 108 to independently trigger the association of a challenge card to a product being scanned. The machine learning model may be utilized to detect the RFID tag component of the challenge piece and associate it from the X-ray detection. The RFID reader provides a backup method for determining that a challenge piece has been put into foreign material detection system 106. If the RFID tag is detected by the RFID reader and the challenge piece is not detected by the foreign material detection system 106, then the challenge is recorded as failed without manual intervention. With an RFID tag, the challenge piece may be placed in or under the product.

The techniques described herein may also utilize a bar code tag place on top of the challenge product sample. A bar code reader located at the entrance machine reads the bar code and identifies the specific challenge piece contained in the challenge product. This tag can be separated from the challenge piece and all of the marker pieces can be removed from the challenge card.

By utilizing these challenge cards with at least one marking component and a challenge material, foreign material detection system 106 can be tested without having to stop a production line or change the mode of a machine. Rather, foreign material detection system 106 can be configured to automatically carry out a challenge procedure upon the detection of the at least one marking component on the challenge card. In instances where carriers for identifying information are further included on the card, the determination of characteristics about the challenge material can be further automated. By maintaining foreign material detection system 106 in a singular mode and by automating the verification procedure, the machinery controlled by computing device 110 and foreign material detection system 106 described herein can operate at a higher efficiency and can continue processing other products while the challenge procedure is carried out by foreign material detection system 106. As it is also simpler to perform the testing, testing is likely to be done more often, thereby increasing the accuracy of the testing procedures.

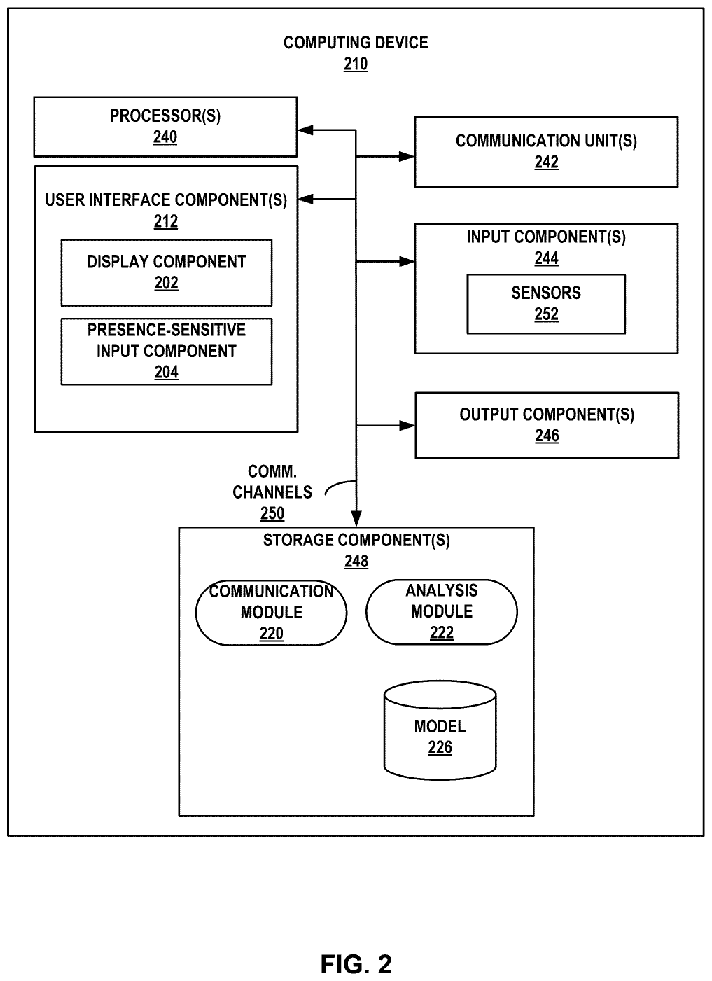

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computing system, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and model 226.

One or more processors 240 may implement functionality and/or execute instructions associated with computing device 210 to capture X-ray images of a good and determine whether a foreign material is present in the good. That is, processors 240 may implement functionality and/or execute instructions associated with computing device 210 to detect challenge cards and other foreign material that may be present in goods during the production process.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to capture X-ray images of a good and determine whether a foreign material is present in the good.

Communication module 220 may execute locally (e.g., at processors 240) to provide functions associated with communicating and controlling external devices, such as X-ray machine 108 of FIG. 1. In some examples, communication module 220 may act as an interface to a remote service accessible to computing device 210. For example, communication module 220 may be an interface or application programming interface (API) to a remote server that controls an X-ray machine or facilitates other communications and outputs.

In some examples, analysis module 222 may execute locally (e.g., at processors 240) to provide functions associated with analyzing X-ray images to determine whether a foreign material is present. In some examples, analysis module 222 may act as an interface to a remote service accessible to computing device 210. For example, analysis module 222 may be an interface or application programming interface (API) to a remote server that utilizes model 226 to detect foreign material in X-ray images.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and model 226. Storage components 248 may include a memory configured to store data or other information associated with modules 220 and 222 and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may control an X-ray machine to capture an image of a good. In some instances, the X-ray machine may be a photon counting X-ray machine. In such instances, the image may be a photon X-ray image.

Analysis module 222 may analyze the image captured by the X-ray machine by applying a foreign material detection algorithm and model 226, which may be a foreign material model, to the image.

Analysis module 222 may determine whether the good includes a foreign material, the foreign material being a challenge card, by detecting at least one marking component on the foreign material when analyzing the image. The challenge card includes the at least one marking component and a challenge material.

In some instances, the at least one marking component is recognizable by the X-ray machine as an identifier of the challenge card or the challenge material. For example, the at least one marking component may have an identifiable feature including at least one of at least two marking components positioned in a particular arrangement, a particular shape of the at least one marking component, or a particular material having different X-ray absorption properties than the challenge material.

For instance, when each of the at least one marking components has different X-ray absorption properties than the challenge material, each of the at least one marking components may be a material that absorbs a greater percentage of X-rays emitted by the X-ray machine than the challenge material.

In other instances, when there are at least two marking components, the particular arrangement of the at least two marking components may be a placement of the at least two marking components in a ring around the challenge material at known rotations around the challenge material and in known ratios of relative size and distance. In still other instances, the particular arrangement of the at least two marking components may include arranging the at least two marking components on a first end of the challenge card with the challenge component is placed on a second end of the challenge card. In general, when the identifiable feature of the marking components is the particular arrangement of the plurality of marking components, the particular arrangement may be any geometrical shape around the challenge component, with analysis module 222 determining that the particular arrangement of the plurality of marking components matches a predefined challenge arrangement.

In still other instances, the identifiable feature of the marking components is that each of the at least one marking components further has a particular shape, such as a square, a triangle, or any other particularly defined shape.

In some instances, analysis module 222 may determine, based on the analyzing of the image, that the good includes the foreign material. In such instances, communication module 220 may output a signal to a notification device (e.g., a user's mobile device, a monitor, a speaker, a light alarm, etc.) indicating that the good should be removed from production. In some examples, communication module 220 may control the foreign material detection system or the transport system to automatically remove the good in addition to or instead of outputting a notification or an alarm.

In some instances, in response to determining that the foreign material is the challenge card, analysis module 222 may update model 226 to include information descriptive of the challenge material. For example, in response to determining that the foreign material is the challenge card, analysis module 222 may detect the challenge material in the image. Analysis module 222 may then determine a unique signature for the challenge material, such as absorption properties, size, shape, etc. Analysis module 222 may update model 226 to include the unique signature for the challenge material. In some examples, communication module 220 may send the updated foreign material model to a server device with an indication of the challenge material.

In some instances, the challenge card further includes a radio frequency identification (RFID) tag. In such instances, analysis module 222 may fail to detect that the good includes the foreign material comprising the challenge card. As a failsafe, in response to failing to detect that the good includes the foreign material comprising the challenge card, communication module 220 may receive, via a radio frequency identification (RFID) reader, a signal including information stored on the RFID tag on the challenge card. In some instances, the signal may also include a notification that the challenge card was erroneously not detected.

In some instances, in addition to or in lieu of the marking components, challenge cards may include a secondary identification tag and a challenge material for the challenge card. In such instances, communication module 220 may receive the secondary identification tag. Analysis module 222 may extract a unique signature for the challenge material for the challenge card from the secondary identification tag. Analysis module 222 may then update model 226 to include the unique signature for the challenge material for the challenge card.

In some such examples, receiving the secondary identification tag may be one or more of receiving, via a radio frequency identification (RFID) reader, the secondary identification tag from an RFID tag on the challenge card, and receiving, via a barcode scanner, the secondary identification tag from a barcode on the challenge card.

In some instances, model 226 may be a universally updated foreign material model.

Communication module 220 may download the universally updated foreign material model from a server device and replace model 226 with the universally updated foreign material model. There may also be instances where communication module 220 may receive software updates to update the foreign material detection algorithm. Communication module 220 may receive these software updates locally or from the server device such that computing device 210 may handle new physical configurations of challenge cards, X-ray machines, or other machinery, or to receive optimizations to the software as the software goes further into development. Communication module 220 may push those updates to itself and analysis module 222.

The above processes may be performed while the X-ray machine is in a scan mode. In such instances, communication module 220 may control the X-ray machine to capture an image of a second good while in the scan mode. Analysis module 222 may analyze the image of the second good captured by the X-ray machine by applying the foreign material detection algorithm and the foreign material model to the image. Analysis module 222 may determine that a second instance of the challenge material has a same signature as the first instance of the challenge material of the challenge card, while also determining that the at least one marking component is not present in the image. In such instances, communication module 220 may output an alert that the second good includes the second instance of the challenge material and that the second good should be removed from production. In other words, computing device 210 may control the machinery in these techniques without changing a mode that the machine is operating in, such that challenge cards and non-challenge foreign material can both be detected in a same scan mode on the machinery.

In some instances, the challenge card further includes an RFID tag. In such instances, communication module 220 may receive, via an RFID reader, additional descriptive information of the challenge material from the RFID tag, such as a name or an identification of the challenge material. Analysis module 222 may update model 226 with the additional descriptive information of the challenge material.

In some other instances, the challenge card further includes one or more of a barcode and a serial number. In such instances, communication module 220 may control a camera to capture an image of the one or more of the barcode and the serial number. Analysis module 222 may determine additional descriptive information of the challenge material based on the one or more of the barcode and the serial number, such as by querying an internet or internal database with the information extracted from the barcode and/or the serial number. Analysis module 222 may update model 226 with the additional descriptive information of the challenge material.

FIGS. 3A-3L are conceptual diagrams illustrating example configurations of challenge cards, as described in accordance with the techniques of this disclosure. While twelve examples of a challenge card are shown in FIGS. 3A-3L, these are merely examples to show the variety of possibilities for marking components and challenge cards in accordance with the techniques of this disclosure. Other arrangements, shapes, or combinations of features are within the scope of this disclosure. In each of FIGS. 3A-3L, challenge cards 302A-302L may include one or more marking components 304 and a challenge material 306, with marking components 304 and challenge material 306 having different X-ray absorption properties. While challenge material 306 appears to be a same challenge material in each of FIGS. 3A-3L, this is merely to show that any configuration of challenge card may be used with a challenge material. Any of these configurations may also be present on a challenge card with different challenge materials of different sizes, shape, or absorption properties.

FIG. 3A is a first example of a challenge card, shown as challenge card 302A. Challenge card 302A includes four marking components 304 positioned around challenge material 306. The particular arrangement of marking components 304 is one marking component 304 above challenge material 306, one below, one to the left, and one to the right. Each of marking components 304 are circular in shape. Either the particular arrangement of marking components 304, the particular number of marking components 304, or the particular shape of marking components 304 may be utilized to determine that challenge card 302A is a challenge card.

FIG. 3B is a second example of a challenge card, shown as challenge card 302B. Challenge card 302B includes two marking components 304 positioned around challenge material 306. The particular arrangement of marking components 304 is one marking component 304 above challenge material 306, and one below. Each of marking components 304 are circular in shape. Either the particular arrangement of marking components 304, the particular number of marking components 304, or the particular shape of marking components 304 may be utilized to determine that challenge card 302B is a challenge card.

FIG. 3C is a third example of a challenge card, shown as challenge card 302C. Challenge card 302C includes one marking component 304 positioned around challenge material 306. The particular arrangement of marking component 304 is one marking component 304 above challenge material 306. Marking component 304 is circular in shape. Either the particular arrangement of marking component 304, the particular number of marking components 304, or the particular shape of marking component 304 may be utilized to determine that challenge card 302C is a challenge card.

FIG. 3D is a fourth example of a challenge card, shown as challenge card 302D. Challenge card 302D includes four marking components 304 positioned around challenge material 306. The particular arrangement of marking components 304 is one marking component 304 above challenge material 306, one below, one to the left, and one to the right. Each of marking components 304 are circular in shape. Either the particular arrangement of marking components 304, the particular number of marking components 304, or the particular shape of marking components 304 may be utilized to determine that challenge card 302D is a challenge card. Challenge card 302D also includes RFID tag 308, which may communicate with an RFID reader in the system scanning challenge card 302D. RFID tag 308 may communicate information to the RFID reader to either describe the unique signature of challenge material 306, to notify the system that a challenge card passed through the machine in case the machine failed to detect the challenge card, or may provide additional identifying information not detectable in an X-ray image to the system.

FIG. 3E is a fifth example of a challenge card, shown as challenge card 302E. Challenge card 302E includes four marking components 304 positioned around challenge material 306. The particular arrangement of marking components 304 is one marking component 304 above challenge material 306, one below, one to the left, and one to the right. Each of marking components 304 are circular in shape. Either the particular arrangement of marking components 304, the particular number of marking components 304, or the particular shape of marking components 304 may be utilized to determine that challenge card 302E is a challenge card. Challenge card 302E also includes barcode 310, which may be read by a camera in the system scanning challenge card 302E. The system may utilize the information from barcode 310 to lookup information in an internet or internal database, with the information including either the unique signature of challenge material 306 or additional identifying information not detectable in an X-ray image to the system.

FIG. 3F is a sixth example of a challenge card, shown as challenge card 302F. Challenge card 302F includes four marking components 304 positioned around challenge material 306. The particular arrangement of marking components 304 is one marking component 304 above challenge material 306, one below, one to the left, and one to the right. Each of marking components 304 are circular in shape. Either the particular arrangement of marking components 304, the particular number of marking components 304, or the particular shape of marking components 304 may be utilized to determine that challenge card 302F is a challenge card. Challenge card 302F also includes serial number 312, which may be read by a camera in the system scanning challenge card 302F. The system may utilize the information from serial number 312 to lookup information in an internet or internal database, with the information including either the unique signature of challenge material 306 or additional identifying information not detectable in an X-ray image to the system.

FIG. 3G is a seventh example of a challenge card, shown as challenge card 302G. Challenge card 302G includes eight marking components 304 positioned around challenge material 306. The particular arrangement of marking components 304 is a ring around challenge material 306. Each of marking components 304 are circular in shape. Either the particular arrangement of marking components 304, the particular number of marking components 304, or the particular shape of marking components 304 may be utilized to determine that challenge card 302G is a challenge card.

FIG. 3H is an eighth example of a challenge card, shown as challenge card 302H. Challenge card 302H includes four marking components 304 positioned around challenge material 306. The particular arrangement of marking components 304 is one marking component 304 above challenge material 306, one below, one to the left, and one to the right. Each of marking components 304 are square in shape. Either the particular arrangement of marking components 304, the particular number of marking components 304, or the particular shape of marking components 304 may be utilized to determine that challenge card 302H is a challenge card.

FIG. 3I is a ninth example of a challenge card, shown as challenge card 302I. Challenge card 302I includes four marking components 304 positioned around challenge material 306. The particular arrangement of marking components 304 is one marking component 304 above challenge material 306, one below, one to the left, and one to the right. Each of marking components 304 are triangular in shape. Either the particular arrangement of marking components 304, the particular number of marking components 304, or the particular shape of marking components 304 may be utilized to determine that challenge card 302I is a challenge card.

FIG. 3J is a tenth example of a challenge card, shown as challenge card 302J. Challenge card 302J includes eight marking components 304 positioned around challenge material 306. The particular arrangement of marking components 304 is a square shape around challenge material 306. Each of marking components 304 are circular in shape. Either the particular arrangement of marking components 304, the particular number of marking components 304, or the particular shape of marking components 304 may be utilized to determine that challenge card 302J is a challenge card.

FIG. 3K is an eleventh example of a challenge card, shown as challenge card 302K. Challenge card 302K includes three marking components 304 positioned around challenge material 306. The particular arrangement of marking components 304 is a triangle around challenge material 306. Each of marking components 304 are shaped like circular disks with a hollow center. Either the particular arrangement of marking components 304, the particular number of marking components 304, or the particular shape of marking components 304 may be utilized to determine that challenge card 302K is a challenge card.

FIG. 3L is a twelfth example of a challenge card, shown as challenge card 302L. Challenge card 302L includes eight marking components 304 positioned around challenge material 306. The particular arrangement of marking components 304 is an octagon around challenge material 306. Each of marking components 304 are circular in shape. Either the particular arrangement of marking components 304, the particular number of marking components 304, or the particular shape of marking components 304 may be utilized to determine that challenge card 302L is a challenge card.

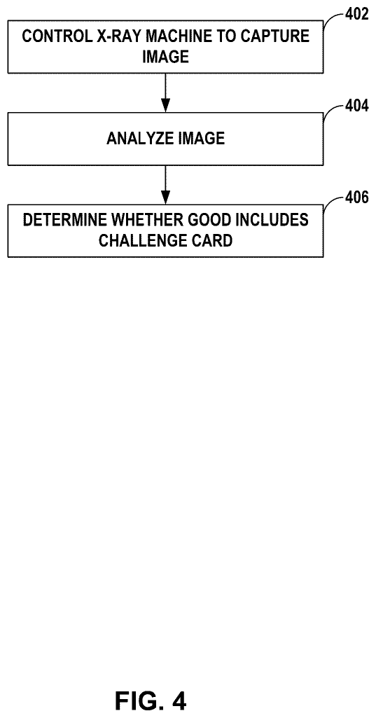

FIG. 4 is a flowchart illustrating an example method for detecting foreign material in a good, in accordance with the techniques described herein. The techniques of FIG. 4 may be performed by one or more processors of a computing device, such as system 100 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

In accordance with the techniques of this disclosure, communication module 220 controls an X-ray machine (e.g., X-ray machine 108 of FIG. 1) to capture an image of a good (e.g., good 104 of FIG. 1) (402). Analysis module 222 analyzes the image captured by the X-ray machine by applying one or more of a foreign material detection algorithm and a foreign material model to the image (404). Analysis module 222 determines whether the good includes a foreign material, the foreign material being a challenge card, by detecting at least one marking component on the foreign material when analyzing the image (406). The challenge card includes the at least one marking component and a challenge material.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
(a) controlling, by one or more processors, an X-ray machine to capture an image of a good;
(b) analyzing, by the one or more processors, the image captured by the X-ray machine by applying a foreign material detection algorithm and a foreign material model to the image; and
(c) determining, by the one or more processors, whether the good includes a foreign material comprising a challenge card by detecting at least one marking component on the foreign material when analyzing the image, wherein the challenge card comprises the at least one marking component and a challenge material.

2. The method of claim 1, further comprising:
(a) determining, by the one or more processors and based on the analyzing of the image, that the good includes the foreign material; and one or more of
(i) outputting, by the one or more processors, a signal to a notification device indicating that the good should be removed from production; and
(ii) controlling, by the one or more processors, a transport system to automatically remove the good from production.

3. The method of claim 1, wherein the at least one marking component is recognizable by the X-ray machine as an identifier of the challenge card or the challenge material.

4. The method of claim 1, wherein the at least one marking component comprises at least one of:
(a) at least two marking components positioned in a particular arrangement;
(b) a particular shape of the at least one marking component;
(c) a particular material comprising different X-ray absorption properties than the challenge material; and
(d) at least two marking components.

5. The method of claim 4, wherein the particular arrangement of the at least two marking components comprises one or more of:
(a) a placement of the at least two marking components in a ring around the challenge material at known rotations around the challenge material and in known ratios of relative size and distance,
(b) an arrangement of the at least two marking components on a first end of the challenge card, and wherein the challenge component is placed on a second end of the challenge card, and
(c) any geometrical shape around the challenge component.

6. The method of claim 4, wherein determining that the good includes the challenge card comprises determining, by the one or more processors, that the particular arrangement of the plurality of marking components matches a predefined challenge arrangement.

7. The method of claim 1, wherein each of the at least one marking components has different X-ray absorption properties than the challenge material,
wherein each of the at least one marking components comprises a material that absorbs a greater percentage of X-rays emitted by the X-ray machine than the challenge material.

8. The method of claim 1, wherein the challenge card further comprises an RFID tag, and wherein the method further comprises:
(a) receiving, by the one or more processors and via an RFID reader, additional descriptive information of the challenge material from the RFID tag; and
(b) updating, by the one or more processors, the foreign material model with the additional descriptive information of the challenge material.

9. The method of claim 1, wherein the X-ray machine comprises a photon counting X-ray machine, and
wherein the image comprises a photon X-ray image.

10. The method of claim 1, wherein each of the at least one marking components further has a particular shape.

11. The method of claim 1, wherein the challenge card further comprises one or more of a barcode and a serial number, and wherein the method further comprises:
(a) controlling, by the one or more processors, a camera to capture an image of the one or more of the barcode and the serial number;
(b) determining, by the one or more processors, additional descriptive information of the challenge material based on the one or more of the barcode and the serial number; and
(c) updating, by the one or more processors, the foreign material model with the additional descriptive information of the challenge material.

12. The method of claim 1, further comprising in response to determining that the foreign material is the challenge card, updating, by the one or more processors, the foreign material model to include information descriptive of the challenge material.

13. The method of claim 12, wherein updating the foreign material model comprises:
(a) in response to determining that the foreign material is the challenge card:
(i) detecting, by the one or more processors, the challenge material in the image;
(ii) determining, by the one or more processors, a unique signature for the challenge material; and
(iii) updating, by the one or more processors, the foreign material model to include the unique signature for the challenge material.

14. The method of claim 1, wherein the challenge card further comprises a radio frequency identification (RFID) tag, and wherein the method further comprises:
(a) failing to detect, by the one or more processors, that the good includes the foreign material comprising the challenge card; and
(b) in response to failing to detect that the good includes the foreign material comprising the challenge card, receiving, by the one or more processors via a radio frequency identification (RFID) reader, a signal including information stored on the RFID tag on the challenge card.

15. The method of claim 1, wherein the challenge card comprises a first challenge card, and wherein a second challenge card comprises a secondary identification tag and a challenge material for the second challenge card,
wherein the method further comprises:
(a) receiving, by the one or more processors, the secondary identification tag;
(b) extracting, by the one or more processors, a unique signature for the challenge material for the second challenge card from the secondary identification tag; and
(c) updating, by the one or more processors, the foreign material model to include the unique signature for the challenge material for the second challenge card, wherein receiving the secondary identification tag comprises one or more of:
(i) receiving, by the one or more processors via a radio frequency identification (RFID) reader, the secondary identification tag from an RFID tag on the second challenge card, and
(ii) receiving, by the one or more processors via a barcode scanner, the secondary identification tag from a barcode on the second challenge card.

16. The method of claim 15, further comprising:
(a) sending, by the one or more processors, the updated foreign material model to a server device with an indication of the challenge material.

17. The method of claim 1, further comprising:
(a) downloading, by the one or more processors, a universally updated foreign material model from a server device; and
(b) replacing, by the one or more processors, the updated foreign material model with the universally updated foreign material model.

18. The method of claim 1, wherein the good comprises a first good, wherein the challenge material comprises a first instance of the challenge material, wherein controlling the X-ray machine to capture the image of the first good comprises controlling, by the one or more processors, the X-ray machine to capture the image of the first good while in a scan mode, and wherein the method further comprises:
(a) controlling, by the one or more processors, the X-ray machine to capture an image of a second good while in the scan mode;
(b) analyzing, by the one or more processors, the image of the second good captured by the X-ray machine by applying the foreign material detection algorithm and the foreign material model to the image;
(c) determining, by the one or more processors, that a second instance of the challenge material has a same signature as the first instance of the challenge material of the challenge card;
(d) determining, by the one or more processors, that the at least one marking component is not present in the image; and
(e) outputting, by the one or more processors, an alert that the second good includes the second instance of the challenge material and that the second good should be removed from production.

19. A device comprising one or more processors configured to:
(a) control an X-ray machine to capture an image of a good;
(b) analyze the image captured by the X-ray machine by applying a foreign material detection algorithm and a foreign material model to the image; and
(c) determine whether the good includes a foreign material comprising a challenge card by detecting at least one marking component on the foreign material when analyzing the image, wherein the challenge card comprises the at least one marking component and a challenge material.

20. A non-transitory computer-readable storage medium having stored thereon instructions that, when executed, cause one or more processors of a computing device to:
(a) control an X-ray machine to capture an image of a good;
(b) analyze the image captured by the X-ray machine by applying a foreign material detection algorithm and a foreign material model to the image; and
(c) determine whether the good includes a foreign material comprising a challenge card by detecting at least one marking component on the foreign material when analyzing the image, wherein the challenge card comprises the at least one marking component and a challenge material.
